(19) United States
(12) Patent Application Publication
(10) Pub. No.: US 2024/0146737 A1
(43) Pub. Date: May 2, 2024

(54) AUTHENTICATION SERVICE FOR AUTOMATED DISTRIBUTION AND REVOCATION OF SHARED CREDENTIALS

(71) Applicant: Dell Products L.P., Round Rock, TX (US)

(72) Inventors: Seth Rothschild, Littleton, MA (US); Rana Afifi, New Cairo (EG); Radia J. Perlman, Redmond, WA (US)

(21) Appl. No.: 17/976,965

(22) Filed: Oct. 31, 2022

(51) Int. Cl. H04L 9/40; H04L 9/08

(52) U.S. Cl. CPC H04L 63/104; H04L 9/0891

(57) ABSTRACT

An apparatus in one embodiment comprises at least one processing device that includes a processor coupled to a memory, with the at least one processing device being configured to provide an authentication service for sharing access credentials of a protected resource among multiple users. The at least one processing device in providing the authentication service for sharing the access credentials is further configured to obtain the access credentials at least in part from a first one of the users, to automatically provide the access credentials to at least one additional one of the users responsive to authentication of the at least one additional user and satisfaction of one or more specified distribution conditions, and to automatically modify the access credentials responsive to satisfaction of one or more specified revocation conditions. The protected resource may comprise, for example, a user account of a website.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to controlling access to information resources, and more particularly to techniques for implementing user authentication in an information processing system.

### BACKGROUND

Information processing systems are typically configured to require user authentication before granting a user device access to protected resources available over a network such as the Internet. For example, online user accounts for various websites generally require successful execution of password-based user authentication protocol for a given account before a user is granted access to that account. It is a common practice for multiple users, such as users on an enterprise work team or other groups of users in a wide variety of other contexts, to share a username and a password for an online account. However, sharing credentials for an account among multiple users in this manner tends to lead to significant security problems, both because of how the credentials are shared and because information is lost about which of the users is using the account at any particular point in time. A need therefore exists for techniques that can provide enhanced security for shared credentials.

### SUMMARY

Illustrative embodiments disclosed herein provide techniques for implementing an authentication service for shared credentials. For example, one or more such embodiments configure an authentication service in a processing platform to manage the shared credentials for a user account of a website in a secure manner, illustratively by providing the shared credentials to a particular designated user only when certain specified conditions are met, and automatically changing the shared credentials when the shared credentials need to be revoked. Such arrangements can advantageously avoid the above-noted problems of conventional practice, for example, by securely controlling how the credentials are shared among the multiple users in a manner that also captures information about which of the multiple users is using the account at any particular point in time.

In an illustrative embodiment, an apparatus comprises at least one processing device that includes a processor coupled to a memory, with the at least one processing device being configured to provide an authentication service for sharing access credentials of a protected resource among multiple users. The at least one processing device in providing the authentication service for sharing the access credentials is further configured to obtain the access credentials at least in part from a first one of the users, to automatically provide the access credentials to at least one additional one of the users responsive to authentication of the at least one additional user and satisfaction of one or more specified distribution conditions, and to automatically modify the access credentials responsive to satisfaction of one or more specified revocation conditions.

The protected resource may comprise, for example, an access-controlled user account of a website and the access credentials may comprise, for example, at least one of a username and a password. A wide variety of other types of protected resources and associated access credentials may be utilized in other embodiments. For example, the access credentials in some embodiments can additionally or alternatively comprise a multi-factor authentication code and/or a session cookie.

In some embodiments, automatically modifying the access credentials responsive to satisfaction of one or more revocation conditions illustratively comprises accessing a designated interface of the website using the access credentials, altering one or more portions of the access credentials via the designated interface of the website to obtain modified access credentials, and storing the modified access credentials for subsequent utilization by at least one of the multiple

These and other illustrative embodiments include, without limitation, systems, apparatus, methods and computer program products comprising processor-readable storage media.

### BRIEF DESCRIPTION OF THE DRAWINGS

FIG. 1 is a block diagram of an information processing system implementing an authentication service for shared credentials in an illustrative embodiment.

FIG. 2 is a flow diagram of a process for implementing an authentication service for shared credentials in an illustrative embodiment.

FIG. 3 shows an example sequence diagram for an authentication service for shared credentials in an illustrative embodiment.

FIG. 4 shows an example screenshot from a user interface of an authentication service for shared credentials in an illustrative embodiment.

FIGS. 5A and 5B show example pseudocode for implementing respective portions of an authentication service for shared credentials in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that these and other embodiments are not restricted to the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other cloud-based system that includes one or more clouds hosting multiple tenants that share cloud resources, as well as other types of systems comprising a combination of cloud and edge infrastructure. Numerous different types of enterprise computing and storage systems are also encompassed by the term “information processing system” as that term is broadly used herein.

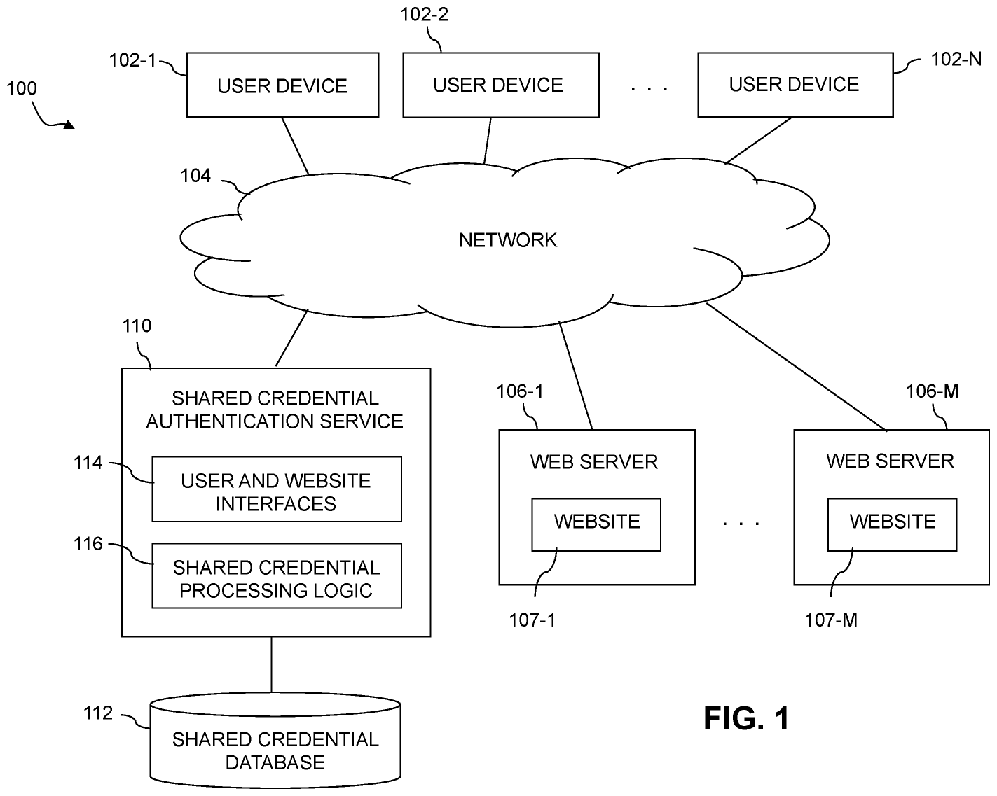

FIG. 1 shows an information processing system 100 configured in accordance with an illustrative embodiment. The information processing system 100 comprises a plurality of user devices 102-1, 102-2, . . . 102-N, collectively referred to herein as user devices 102. The user devices 102 are coupled to a network 104. Also coupled to the network 104 are a plurality of web servers 106-1, . . . 106-M, illustratively implementing respective websites 107-1, . . . 107-M, and shared credentials authentication service 110, also referred to herein as simply authentication service 110. The authentication service 110 is coupled to or otherwise associated with a shared credential database 112. The authentication service 110 comprises user and website interfaces 114 and shared credential processing logic 116. The authentication service 110 is an example of what is more generally referred to herein as an “authentication service for shared credentials.” In some embodiments, such an authentication service for shared credentials can be configured at least in part as an authentication layer arranged between one or more of the user devices 102 and one or more of the websites 107.

The authentication service 110 may be implemented on a separate processing platform comprising one or more processing devices, each having at least one processor coupled to at least one memory. In some embodiments, the authentication service 110 may be implemented at least in part on a same processing platform as one or more of the web servers 106. Additionally or alternatively, the authentication service 110 may be implemented at least in part on a same processing platform as one or more of the user devices 102. Accordingly, illustrative embodiments disclosed herein are highly flexible in terms of the particular manner in which the authentication service 110 is implemented within the system 100. In addition, the configuration of the web servers 106 and websites 107 can be varied relative to the example arrangement shown in FIG. 1. For example, multiple websites may be implemented on a single web server, or a single website may be distributed across multiple web servers.

It should also be noted that, although only a single instance of authentication service 110 is shown in FIG. 1, this is by way of example and not limitation, as the system 100 may comprise multiple instances of authentication service 110 and its associated shared credential database 112. For example, there may be separate instances of the authentication service 110 and its associated shared credential database 112 deployed for each of at least a subset of the web servers 106. Such deployment may include at least partial implementation of instances of the authentication service 110 and its associated shared credential database 112 within the respective corresponding ones of the web servers 106. Numerous other arrangements can be used for deployment of one or more instances of authentication service 110 and its associated shared credential database 112 in the system 100.

A given one of the user devices 102 may comprise, for example, a mobile telephone, a laptop computer, a tablet computer, a desktop computer or another type of device from which a user authenticates to the authentication service 110 in order to obtain access to secure content of one or more of the websites 107. Such user devices 102 are examples of what are more generally referred to herein as “processing devices.” It is also possible that one or more of the user devices 102 may be implemented at least in part using cloud-based virtualization infrastructure such as a virtual machine or container. A given one of the user devices 102 is illustratively equipped with at least one web browser, such as a Google Chrome web browser, a Microsoft Edge web browser, a Microsoft Internet Explorer web browser, a Mozilla Firefox browser, or another suitable web browser. Combinations of multiple distinct web browsers may be implemented on the given user device.

The user devices 102 in some embodiments comprise respective computers associated with a particular company, organization or other enterprise. In addition, at least portions of the information processing system 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities. For example, in some embodiments, one or more of the user devices 102 can include Internet of Things (IoT) sensors and other types of IoT processing devices that authenticate to the authentication service 110 using a shared credential. The term “user device” as used herein is intended to be broadly construed so as to encompass IoT processing devices as well as other types of devices that are configured to participate in a user authentication protocol with the authentication service 110 using shared credentials.

Although multiple user devices 102 and web servers 106 are shown in the FIG. 1 embodiment, other embodiments can include a single user device and/or a single web server rather than multiple instances of such components. The variables N and M denoting respective numbers of user devices 102 and web servers 106 are therefore considered arbitrary integer values greater than or equal to one.

The network 104 is assumed to comprise a portion of a global computer network such as the Internet, although other types of networks can be part of the information processing system 100, including a wide area network (WAN), a local area network (LAN), a satellite network, a telephone or cable network, a cellular network such as a 4G or 5G network, a wireless network such as a WiFi, WiMAX, Bluetooth or near field communication (NFC) network, or various portions or combinations of these and other types of networks. The information processing system 100 in some embodiments therefore comprises combinations of multiple different types of networks each comprising processing devices configured to communicate using IP or other related communication protocols. Numerous alternative networking arrangements are possible in a given embodiment, as will be appreciated by those skilled in the art.

The shared credential database 112 stores shared credential accounts and associated authentication information such as usernames and passwords for each of one or more users of the user devices 102. For example, the authentication service 110 can have multiple accounts for respective different groups of users and their associated shared credentials. Each user can illustratively use a single sign-on (SSO) arrangement within an enterprise computer system to access the authentication service 110.

The shared credential database 112 illustratively stores passwords, usernames, login cookies and other types of user account information for respective ones of a plurality of user accounts. The passwords, usernames, login cookies and other types of user account information may be stored in the shared credential database 112 in encrypted form. Examples of other types of user account information that may be stored in the shared credential database 112 include other characteristics of the user and/or the user devices of that user, as well as other types of information characterizing user behavior. These other types of user account information can further include any type of information that may be applied in a given user authentication protocol implemented within system 100.

The shared credential database 112 in the present embodiment is illustratively implemented as part of one or more storage systems coupled to or otherwise associated with one or more processing devices that are utilized to implement the authentication service 110. Such storage systems can comprise any of a variety of different types of storage including by way of example network-attached storage (NAS), storage area networks (SANs), direct-attached storage (DAS) and distributed DAS, as well as combinations of these and other storage types, including but not limited to flash storage, storage arrays, software-defined storage, cloud storage and object-based storage.

Although shown as being arranged externally to the authentication service 110 in the illustrative embodiment of FIG. 1, the shared credential database 112 in some embodiments can be at least in part internal to the authentication service 110. Also, at least portions of the shared credential database 112 can additionally or alternatively be implemented as an in-memory database utilizing one or more memories of at least one processing device that implements the authentication service 110.

As indicated above, sharing credentials for an account among multiple users under conventional practice tends to lead to significant security problems, both because of how the credentials are shared and because information is lost about which of the users is using the account at any particular point in time.

Illustrative embodiments disclosed herein provide techniques for implementing an authentication service for shared credentials. For example, one or more such embodiments configure an authentication service of a processing platform to manage the shared credentials for a user account of a website in a secure manner, illustratively by providing the shared credentials to a particular designated user only when certain specified conditions are met, and automatically changing the shared credentials when the shared credentials need to be revoked. Such arrangements can advantageously avoid the above-noted problems of conventional practice, for example, by securely controlling how the credentials are shared among the multiple users in a manner that also captures information about which of the multiple users is using the account at any particular point in time.

As an illustration of an example shared credential context, consider a user Alice that is a software developer and has website credentials that she wants to share with her entire software development team. This is a common practice for external websites, such as a team GitHub or Twitter account, although similar issues arise in the context of “fake” users created by information technology (IT) professionals within an organization to do specific things such as access a database. It is to be appreciated that the latter users are also considered “users” as that term is intended to be broadly construed herein.

Under conventional practice, Alice may utilize one of the following options regarding her web site credentials:
1. She can send the credentials to whichever team member asks for them via email or instant message.
2. She can never share them with anyone, and handle all the cases where those credentials are needed herself.
3. She can upload the credentials to a shared password manager, which may include, for example, a password vault. While this is theoretically a better choice than item 1 above for keeping passwords out of plaintext, users tend to write down passwords obtained from a password vault to facilitate entry at their respective local machines, which seriously undermines the security of that approach.

For sending the credentials, not only does Alice have to worry about whether or not the credentials are sent in plaintext, as they often are, but she has absolutely no way of knowing if they're being used, and which person she has sent them to in the past is using them. Furthermore, revoking access to the site from only one person can be inefficient, since you then have to manually redistribute the password to everyone who should still have access. Lastly, humans are notoriously bad at choosing passwords, and they tend to choose worse passwords when they have to remember and type them often.

Of course, the most secure option under conventional practice is for Alice not share the credentials at all, in accordance with item 2 above. But depending on the task, this can be an unattractive option since it means that Alice always needs to be available whenever someone wants to do something.

In illustrative embodiments disclosed herein, these and other problems are addressed at least in part by having Alice provide the credentials for the website to the authentication service 110, which is illustratively configured to control distribution of the credentials to other users and to navigate to the website and change the credentials when specified conditions are met. As will be described in more detail elsewhere herein, such an arrangement can advantageously simplify the revocation process while also maintaining a record of which users are using the account and at what times.

In some embodiments, the authentication service 110 is configured to control distribution and revocation of access credentials for a protected resource among multiple users, such as user associated with respective ones of the user devices 102, or other types and arrangements of multiple users. The authentication service 110 illustratively obtains the access credentials at least in part from a first one of the users, automatically provides the access credentials to at least one additional one of the users responsive to authentication of the at least one additional user and satisfaction of one or more specified distribution conditions, and automatically modifies the access credentials responsive to satisfaction of one or more specified revocation conditions.

Such functionality of the authentication service 110 is illustratively implemented at least in part by shared credential processing logic 116, through interaction with the user devices 102 and the web servers 106 via respective user and website interfaces 114. For example, example algorithms or other processes and associated program code as described elsewhere herein are illustratively implemented at least in part by user and website interfaces 114 and shared credential processing logic 116.

In some embodiments, the obtaining of the access credentials at least in part from a first one of the users may be performed at least in part responsive to authentication of the first user by the authentication service 110, although other embodiments can obtain the access credentials in whole or in part without the need for authentication of the first user.

In some embodiments, the protected resource for which the access credentials are shared among the multiple users comprises an access-controlled user account of a website and the access credentials comprise at least one of a username and a password. A wide variety of other types of protected resources and associated access credentials may be utilized in other embodiments. For example, the access credentials in some embodiments can additionally or alternatively comprise a multi-factor authentication code and/or a session cookie.

By way of example, the one or more specified distribution conditions utilized by the authentication service 110 to control distribution of the access credentials to other users illustratively comprise one or more of the following, although additional or alternative distribution conditions can be used in other embodiments:
1. Receiving a request for the access credentials by the at least one additional user.
2. Determining that the request originates from a user device having one or more specified characteristics.
3. Determining that the request originates from a network having one or more specified characteristics.
4. Determining that the request originates from a particular specified user of the multiple users.
5. Receiving an approval of the request from the first user.
6. Receiving an approval of the request from at least one other one of the multiple users designated by the first user as being authorized to approve the request.
7. Receiving an approval of the request from at least one further user that is not one of the multiple users.

In the foregoing example, the request is illustratively received from the at least one additional user via a corresponding user interface of the authentication service 110. The various approvals that may be required are similarly received via respective corresponding user interfaces of the authentication service 110.

The authentication service 110 in some embodiments is configured to permit the first user to designate different sets of one or more distribution conditions for controlling provision of the access credentials to different ones of the multiple users.

Again by way of example, the one or more specified revocation conditions comprise at least expiration of a specified time period (e.g., 30 minutes) for which the at least one additional user is permitted to utilize the access credentials. In some embodiments, the specified time period may be established at least in part by the first user, or possibly by a requesting user, via a corresponding user interface of the authentication service 110, while in other embodiments the specified time period may comprise a predetermined time period not selectable by the first user or requesting user. In still further embodiments, the specified time period is selectable by the first user or a requesting user subject to a predetermined maximum value. Numerous alternative arrangements of these and other revocation conditions can be used in illustrative embodiments herein.

Accordingly, some embodiments are configured to effectively allow additional authorization rules or other conditions to be used in controlling access to an arbitrary third-party website, without requiring any modification to that website. The following is one possible example set of conditions that may be added in a given embodiment utilizing the authentication service 110:
1. The request must come from the internal network or VPN.
2. The request must come from particular people or a particular team inside a company or other enterprise.
3. The credentials grant requires manager or vice-president level approval, or a particular multi-level approval process.
4. The credentials grant cannot exceed a maximum duration (e.g., 30 minutes).

This is just one example of a possible combination of multiple conditions for controlling distribution and revocation of shared credentials, and numerous other combinations of additional or alternative conditions can be used.

In some embodiments in which the protected resource comprises an access-controlled user account of a website, automatically modifying the access credentials responsive to satisfaction of one or more revocation conditions illustratively comprises accessing a designated interface of the website using the access credentials, altering one or more portions of the access credentials, such as a password for the user account, via the designated interface of the website to obtain modified access credentials, and storing the modified access credentials for subsequent utilization by at least one of the multiple users. For example, the modified credentials can be stored in the shared credential database 112.

The authentication service 110 can be adapted for use in multi-factor authentication environments. For example, in embodiments in which a multi-factor authentication requirement of the protected resource can be disabled by a user having the shared credentials, the first user can utilize the access credentials to temporarily disable the multi-factor authentication requirement of the protected resource. Such an arrangement is appropriate in some embodiments as the authentication service 110 separately authenticates each of the users to which it provides the shared access credentials, illustratively via its own multi-factor authentication protocol carried out with those users. In some embodiments, the authentication service 110 can be configured to assist the first user with the temporary disabling of the multi-factor authentication requirement of the protected resource, or may be otherwise configured to implement or facilitate such temporary disabling functionality.

As another example, the authentication service 110 can store information characterizing a registration of the authentication service 110 to receive multi-factor authentication codes generated in conjunction with attempts to access the protected resource. In such an embodiment, a multi-factor authentication requirement of the protected resource remains enabled, but the authentication service 110 has an associated email address, phone number or other similar identifying information that is registered with the protected resource to receive any multi-factor authentication code generated for attempts to access the protected resource. For example, if the multi-factor authentication is Short Message Service (SMS) based, then the system 100 can be configured to use an SMS service such as Twilio to assign the authentication service 110 a phone number, and the owner of the user account for which credentials are being shared can register that assigned phone number as the number for verification. The authentication service in such an embodiment is configured to automatically forward authentication codes sent to its assigned phone number to the appropriate user.

It is to be appreciated that other embodiments need not utilize multi-factor authentication, or may utilize alternative techniques to accommodate multi-factor authentication.

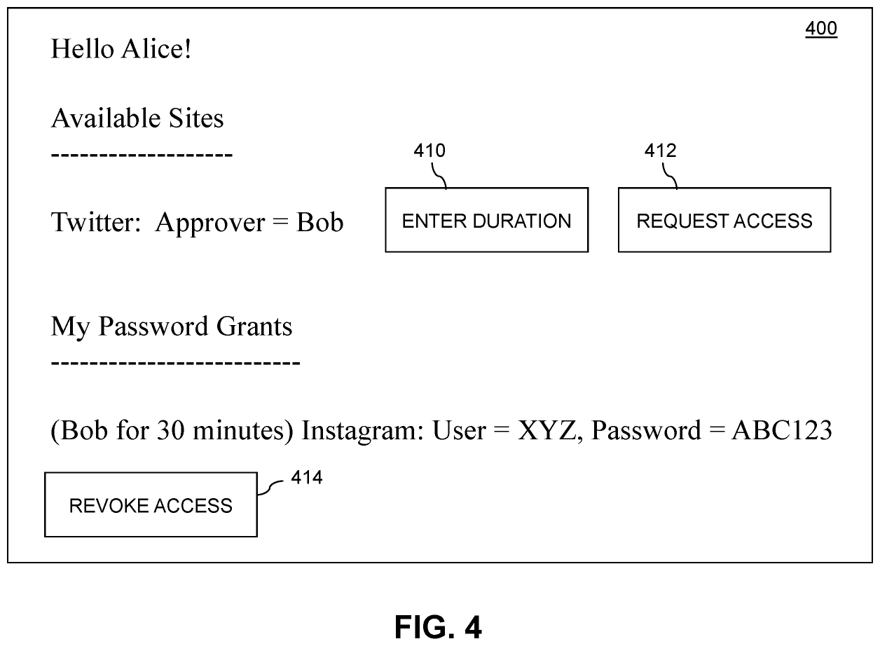

Additional illustrative embodiments will now be described with reference to two users, referred to as Alice and Bob. It is assumed that Alice and Bob are part of a development team that would like to share access credentials for a single user account of a website, such as a GitHub or Twitter website. The authentication service 110 in such embodiments may be implemented, for example, as a web application that is arranged “in front” of the website. For example, it can be arranged on the same processing platform as the website, or as a separate processing platform, and such a processing platform is accessed by the multiple users of the team in order to share the access credentials. The multiple users of the team that are sharing the access credentials for the user account of the website can each authenticate to the authentication service 110 using their personal SSO credentials or other suitable individual credentials. After authenticating a given one of the multiple users, the given user is presented with a user interface, an illustrative example of which is shown in FIG. 4 for the user Alice. Inputs provided via such user interfaces are utilized by the authentication service 110 to control the distribution and revocation of the shared access credentials of the multiple users, as described in more detail below.

Distributing Shared Credentials

Assume that Alice has credentials S for a user account on a website example.com, and wishes to share those credentials with other users, illustratively fellow team members. In order to share these credentials, Alice initiates performance of the following steps, although additional or alternative steps could be used in other embodiments:
1. Alice uses a browser to navigate to a shared credential authentication service website which is an implementation of the authentication service 110. Assume that this web site is auth_layer.company.com. Note that auth_layer.company.com could be deployed on an internal company network or other enterprise network utilized by the team members, or could be external to such networks. It is assumed that the auth_layer.company.com website incorporates functionality for authentication of the multiple users, illustratively via their individual SSO credentials or other suitable user credentials, also referred to in this example as company credentials.
2. Alice authenticates with auth_layer.company.com using her company credentials. Any of a wide variety of authentication protocols can be utilized in this step, including multi-factor authentication protocols.
3. Alice stores the credentials S on auth_layer.company.com. Depending on the implementation, she can also specify which users should have default access, which users should be able to grant access, and/or which users should be allowed to request access to S. Also depending on the implementation, she can set additional constraints on distribution such as the maximum duration of access to grant, if the user must be connected to the internal network to get access, if the user must be on an enterprise-owned machine, and/or if there is a specific multi-level approval process for the credentials.

When the user Bob that is allowed to request access to the credentials S wants access to the credentials S, Bob initiates performance of the following steps, although again additional or alternative steps could be used in other embodiments:
1. Bob logs in to auth_layer.company.com with his company credentials.
2. Since Bob is allowed to request access, he will see that he is allowed to request credentials for the website example.com. For example, via a user interface presented by the authentication service 110 he can click a button to request those credentials, and may also be permitted to enter a duration. Note that if one or more additional distribution constraints have been set, illustratively as part of the shared credential setup previously initiated by Alice above, such as the requirement that Bob request from an enterprise laptop or virtual private network (VPN), such additional constraints can be enforced at this point.
3. Alice, or another user who is authorized to approve the request, either approves or rejects Bob's request for the credentials S for the requested duration. Again, it additional rules or other constraints were set for access to the credentials S, like the requirement of multiple approvers, then multiple approvers need to approve the request before Bob can get access.
4. If the request is approved, Bob sees via his user interface on auth_layer.company.com that he has been granted access and can see the credentials S in plaintext. He can then copy/paste the credentials S into a user interface of example.com to log in and use the account for the specified duration. Advantageously, such an arrangement does not require any change to the example.com website for which the credentials are shared among the multiple users.

Revoking of Shared Credentials

Illustrative embodiments disclosed herein include the ability to revoke credentials in an automatic and efficient manner. For example, some embodiments herein implement credentials with a specific lifespan after which the credentials are automatically changed, illustratively by interaction between the authentication service 110 and the particular website for which the credentials are shared by the multiple users. This is illustratively done as follows:
1. A site-specific method is implemented by the authentication service 110 to navigate to the website example.com, illustratively to its password reset page. This illustratively includes logging in to the web site example.com using the existing credentials S. It is to be appreciated that such methods are site-specific in that different websites will typically have different interfaces for obtaining access thereto.
2. When Bob is granted access to the website example.com for a specified period of time, the authentication service 110 makes a record of that grant time. When the time is expired, the authentication service 110 automatically navigates to the website example.com using the appropriate site-specific method mentioned above and using the credentials S, changes the credentials for example.com to S′. It should be noted that the new credentials 5′ will need to be generated in a manner consistent with the applicable rules of the website example.com.

The above example revocation process utilizes a site-specific method to navigate to the change password page or other web page of the example.com website to change the credentials at the website. A detailed example of a site-specific method for the Twitter website is shown in the Appendix of the present disclosure.

If the website example.com includes an application programming interface (API), that API can be utilized to change the credentials as part of the site-specific method. However, it is to be appreciated that illustrative embodiments herein can change the credentials for the website without use of such APIs.

It should be noted that a malicious user provided with access to the credentials could change the credentials and thereby exceed the duration of the credential grant. Moreover, when such a user changes the credentials, none of the other users on the team will be able to access the website account, so it is effectively locked out to those other users. Although this is a potentially problematic situation, illustrative embodiments provide significant improvements in this situation, relative to conventional practice, in terms of providing an ability to identify exactly which user changed the credentials (e.g., the user currently granted access) as well as rapid notification of the malicious change in credentials, since the authentication service 110 will fail to change the credentials from S to S′ when the grant time of the malicious user has expired.

As mentioned previously, illustrative embodiments can be configured to accommodate multi-factor authentication for the website for which credentials are shared. As another example, if the website example.com requires a multi-factor authentication code, the authentication service 110 can be configured to restrict the access to that multi-factor authentication code so that a user only has access to it for a limited amount of time, or not at all. The website might also be configured in such a way that the authentication service 110 can transfer only the session cookie without exposing the real credentials S. The session cookie in such an embodiment not only expires by itself but since many websites require a current password in order to change the password, such an embodiment would prevent a malicious user from changing the password. It should be noted in this regard that the term “access credentials” as used herein is intended to be broadly construed, so as to encompass multi-factor authentication codes, session cookies and/or other information utilized to authenticate to a website for access to a user account or other protected resource.

Some embodiments are configured to support an ability to grant the access credentials to multiple users in the same time frame. For example, the website auth_layer.company.com can be configured to so that an additional user Calvin can request the credentials, but assuming his request is approved, his grant will expire at the same time as the previous grant to Bob. This concurrent grant arrangement prevents exact identification of a malicious user, should that situation arise, but nonetheless may be desirable in some embodiments. Alternatively, the website auth_layer.company.com could be configured to expressly prohibit such concurrent usage of the shared credentials, illustratively by preventing Calvin from requesting a grant until such time as the grant to Bob expires.

As indicated previously, a shared credential authentication service of the type described above can be implemented on a separate processing platform, such as a separate web server, relative to the web servers or other processing platforms that support the websites or other protected resources for which credentials are shared via the authentication service. It is also possible for at least portions of the authentication service to be deployed on one or more of the same platforms as the web servers. Numerous alternative arrangements are possible, including local arrangements in which at least portions of the authentication service are deployed on a user device. As one possible example, if Alice wants to share her password for somesite.com with Bob, she can run the authentication service locally on her laptop or other user device and direct the authentication service to automatically expire the password in 30 minutes, or however long she wants to give Bob. When the 30 minutes are up, the authentication service on her user device navigates to somesite.com to implement the password change, which revokes Bob's access to somesite.com. Such an arrangement would necessitate that Alice's user device is on and can access somesite.com at the revocation time.

It is to be appreciated that the particular set of system elements and other components and associated functionality as illustrated in the system 100 of the FIG. 1 embodiment is presented by way of example only, and a wide variety of alternative arrangements can be used in other embodiments. For example, the functionality associated with components 114 and 116 in other embodiments can be combined into a single component, or separated across a larger number of components. Additionally or alternatively, at least portions of the components 114 and 116 may be implemented at least in part in the form of software comprising program code stored in memory and executed by a processor.

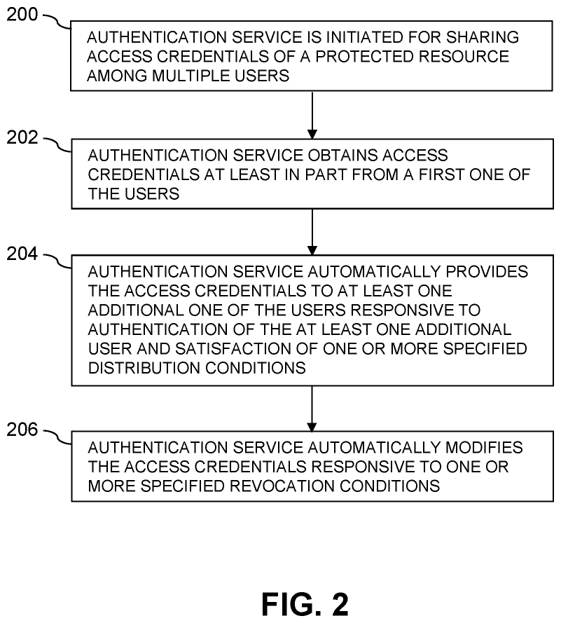

An illustrative embodiment of an example process for implementing an authentication service for shared credentials in the information processing system 100 will now be described in more detail with reference to the flow diagram of FIG. 2.

In this embodiment, it is assumed that users associated with respective ones of the user devices 102 would like to share access credentials for a protected resource, such as a single access-controlled user account of a website.

The process as illustrated includes steps 200 through 206, which are illustratively performed primarily by the authentication service 110. It is to be understood that this particular process is only an example, and additional or alternative processes can be carried out in other embodiments.

In step 200, an authentication service is initiated for sharing access credentials of a protected resource among multiple users. The authentication service can run on a separate web server or other processing platform, relative to one or more processing platforms that support the protected resource. However, alternative arrangements are possible. For example, in some embodiments, the authentication service is run at least in part locally on a user device of at least one of the multiple users.

In step 202, the authentication service obtains the access credentials at least in part from a first one of the users. For example, the first user can provide the access credentials directly to the authentication service, illustratively by entering them into a user interface of a corresponding website, although other techniques can be used to allow the authentication service to obtain the access credentials. In some embodiments, the first user may be authenticated by the authentication service in conjunction with this step.

In step 204, the authentication service automatically provides the access credentials to at least one additional one of the users responsive to authentication of the at least one additional user and satisfaction of one or more specified distribution conditions. Examples of such distribution conditions are provided elsewhere herein, and the term “distribution condition” is intended to be broadly construed to encompass these and other arrangements.

In step 206, the authentication service automatically modifies the access credentials responsive to satisfaction of one or more specified revocation conditions. Examples of such revocation conditions are provided elsewhere herein, and the term “revocation condition” is also intended to be broadly construed to encompass these and other arrangements.

The particular processing operations and other system functionality described in conjunction with the flow diagram of FIG. 2 are presented by way of illustrative example only, and should not be construed as limiting the scope of the present disclosure in any way. Alternative embodiments can use other types of processing operations to implement an authentication service for shared credentials. For example, certain steps may be performed at least in part concurrently with one another rather than serially. As additional examples, at least portions of the process steps may be repeated periodically for different authentication service execution instances, and multiple such instances can be performed in parallel with one another to provide respective authentication services for different sets of multiple users, different shared credentials and/or different protected resources.

Also, functionality such as that described in conjunction with the flow diagram of FIG. 2 can be implemented at least in part in the form of one or more software programs stored in program code of at least one memory and executed by at least one processor in one or more processing devices implementing an authentication service for shared credentials as disclosed herein. A storage device or other memory having executable program code of one or more software programs embodied therein is an example of what is more generally referred to herein as a “processor-readable storage medium.”

The foregoing example process is therefore illustrative only, and should not be viewed as limiting the scope of any particular embodiment in any way. Those skilled in the art will appreciate that numerous alternative authentication service arrangements for shared credentials can be used in other embodiments.

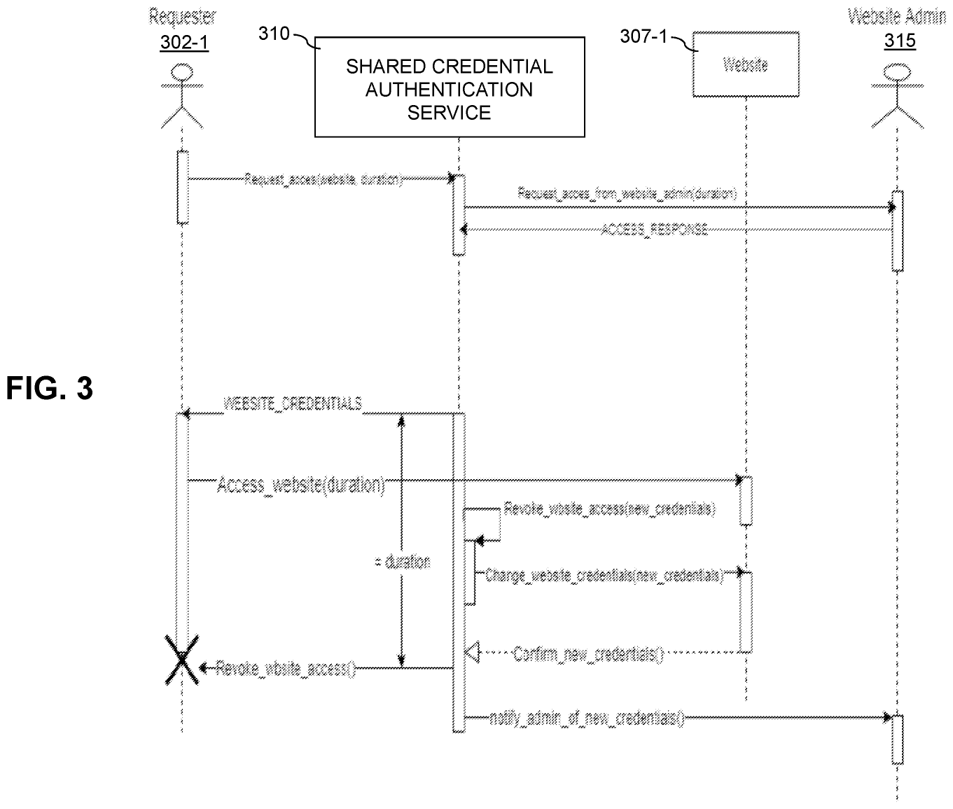

Additional illustrative embodiments will now be described with reference to FIGS. 3, 4, 5A and 5B.

FIG. 3 shows an example sequence diagram for an authentication service for shared credentials in an illustrative embodiment. In this example sequence diagram, a user requests and obtains access to a specific website using shared credentials. More particularly, the user is denoted in the figure as a requester 302-1 illustratively associated with a corresponding user device. The requester 302-1 obtains shared credentials for accessing a user account of a website 307-1 from a shared credential authentication service 310, also referred to as simply authentication service 310. The web site 307-1 has an associated web site administrator (“admin”) 315. Such an administrator in some embodiments may be viewed as an example of what is more generally referred to herein as a “first user” of a group of multiple users that share credentials for accessing a protected resource.

In this embodiment, the requester 302-1 sends a request to authentication service 310 requesting access to a user account of website 307-1 for a particular specified duration. The authentication service 310 then interacts with the website administrator 315 to obtain access credentials for the user account of the website 307-1. The requester 302-1 utilizes the access credentials to access the user account of the website 307-1 for at least a portion of the granted duration. At or near the expiration of that duration, the authentication service 310 interacts with the website 307-1 to change the credentials, resulting in new credentials. The revocation of access of the requester 302-1 is completed, and the new credentials are provided by the authentication service 310 to the website administrator 315.

It is to be appreciated that the particular messages exchanged between system entities in the FIG. 3 embodiment is exemplary only, and can be varied in other embodiments. For example, the ordering of the one or more of interactions and their specific format and execution can be varied in other embodiments.

Also, the protected resource in this embodiment can be the entire website 307-1, rather than any particular user account on that website. In other words, the website 307-1 in its entirety may be considered the protected resource in some embodiments. Numerous alternative arrangements of multiple users, protected resources and shared credentials may present in other embodiments.

As another example, the protected resource may comprise an external interface to a protected processing device or set of such processing devices. For example, the techniques disclosed herein can be used to allow multiple users to share access credentials for a management interface to a processing device.

Referring now to FIG. 4, an example screenshot is shown, illustratively from at least a portion of a user interface 400 of an authentication service for shared credentials. This example screenshot illustrates a portion of the user interface 400 for a particular user, illustratively a user Alice. The user interface 400 shows the names of a number of websites for which credentials can be shared via the shared credential authentication service, in this case a Twitter website and an Instagram web site.

For the Twitter website, the user interface 400 indicates that shared credentials are available for Alice to request for a particular duration, via the icons 410 and 412. Another user, illustratively a user Bob, is the designated approver for the sharing of the Twitter credentials. Accordingly, if Alice selects or otherwise enters a duration (e.g., 30 minutes) via icon 410 and then requests access to the Twitter credentials for that duration via icon 412, the request will go to Bob for approval, and if approved by Bob will result in Alice being provided with the Twitter credentials for the specified duration.

For the Instagram website, Alice is the designated approver, and the user interface 400 also indicates the current grants of shared credentials made by Alice. In this case, Alice has granted Bob the shared Instagram credentials for a duration of 30 minutes. The Instagram credentials in this embodiment include a username (XYZ) and a password (ABC123), as shown in the user interface 400. Alice can revoke the shared credentials by activating icon 414, which will cause the authentication service to navigate to the Instagram website to change the password on the Instagram account of the username XYZ.

With respect to the Instagram credentials, Alice controls the access to those credentials and serves as what is more generally referred to herein as a “first user” in the context of those credentials. Such a user in the context of the FIG. 3 embodiment illustratively corresponds to the website administrator 315. Similarly, with respect to the Twitter credentials, Bob controls the access to those credentials and serves as what is more generally referred to herein as a “first user” in the context of those credentials. Accordingly, the FIG. 4 example illustrates that different users can have different roles with respect to different shared credentials, with all of those roles and associated functionality being reflected in their respective corresponding user interfaces of the authentication service.

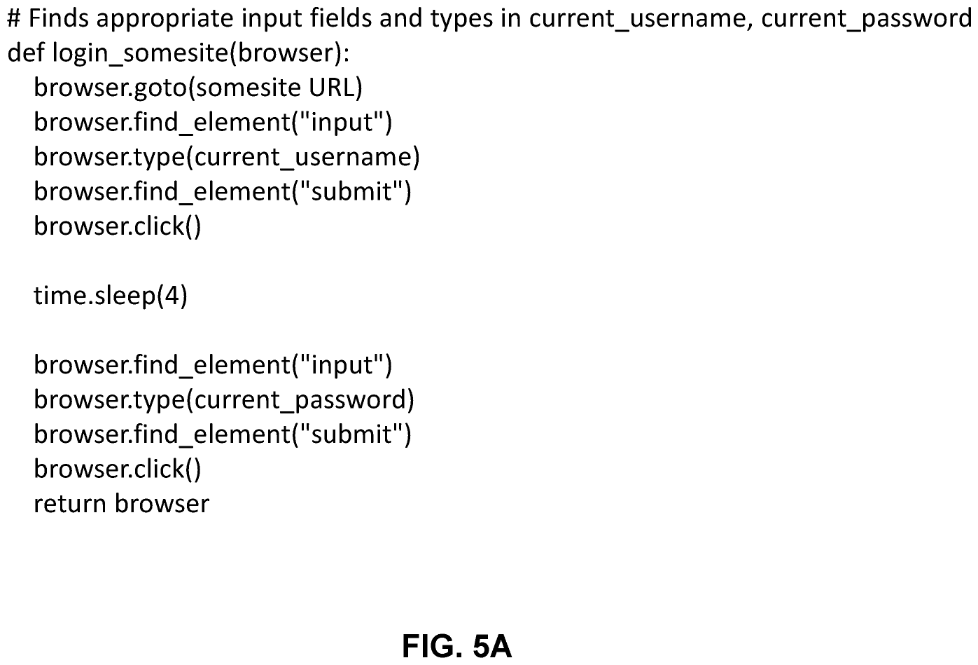

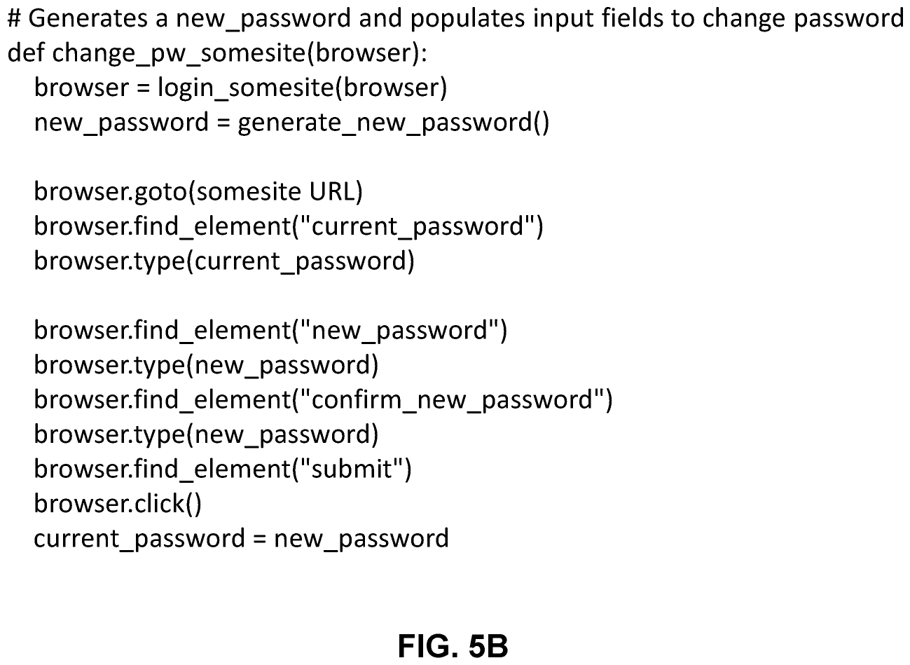

FIGS. 5A and 5B show example pseudocode for implementing respective portions of an authentication service for shared credentials in an illustrative embodiment. In this embodiment, the pseudocode shown in FIG. 5A implements a portion of the shared credentials authentication service that navigates to a particular website (“somesite”) via its Uniform Resource Locator (URL), locates the username field, enters and submits the username, locates the password field, and enters and submits the password. The pseudocode shown in FIG. 5B generates a new password and populates the input fields of the particular website in order to change the password, thereby revoking any previous grants made for the old password.

It is to be appreciated that the actual program code utilized to implement functionality such as that illustrated in FIGS. 5A and 5B is typically site-specific, and so different sets of program code may be used in order to interact with different websites, for example, in order to locate the appropriate web page elements and/or hit submit buttons for different login pages and password change pages.

As indicated previously, the Appendix of the present disclosure shows a more detailed example of site-specific program code implementing a site-specific method for interacting with the Twitter website. It should be understood that numerous alternative program code arrangements can be used in providing a shared credential authentication service as disclosed herein. For example, the program code of the Appendix is illustratively implemented in Python using Selenium WebDriver, but other types of program code written in other programming languages can also be used.

Illustrative embodiments provide a number of significant advantages relative to conventional arrangements.

For example, one or more such embodiments securely control how credentials for a protected resource are shared among multiple users in a manner that can also capture information about which of the multiple users is using the credentials at any particular point in time. Such embodiments therefore facilitate the secure sharing of such credentials among multiple users, and enable better tracking of which users are using the corresponding protected resources at which times.

Illustrative embodiments can be configured to effectively allow additional authorization rules or other distribution and/or revocation conditions to be used in controlling access to an arbitrary third-party website or other protected resource, without requiring any modification to that web site or other protected resource.

Accordingly, some embodiments disclosed herein are advantageously configured so as to avoid the need for any change to a website for which the credentials are shared among the multiple

These and other embodiments provide an efficient mechanism for secure sharing of passwords and other credentials among multiple users with automated distribution and revocation of the shared credentials via a shared credential authentication service.

The disclosed techniques are simple to implement in illustrative embodiments, and can be adapted in a straightforward manner for use with a wide variety of different types of authentication service implementations involving different protected resources and access credentials.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

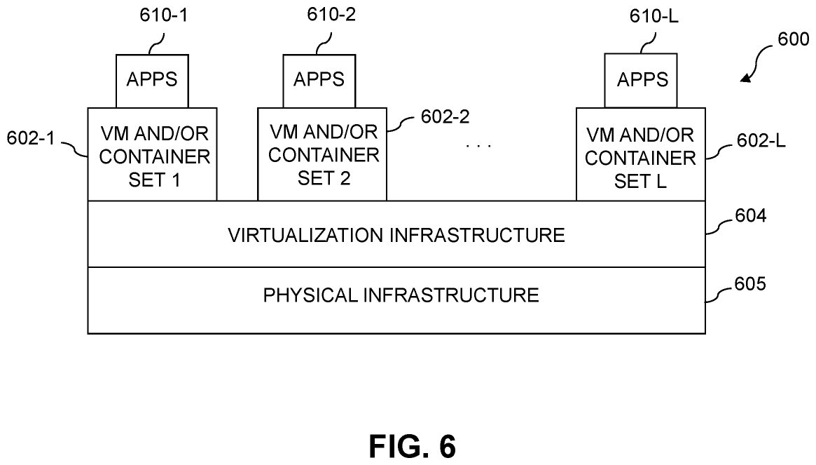

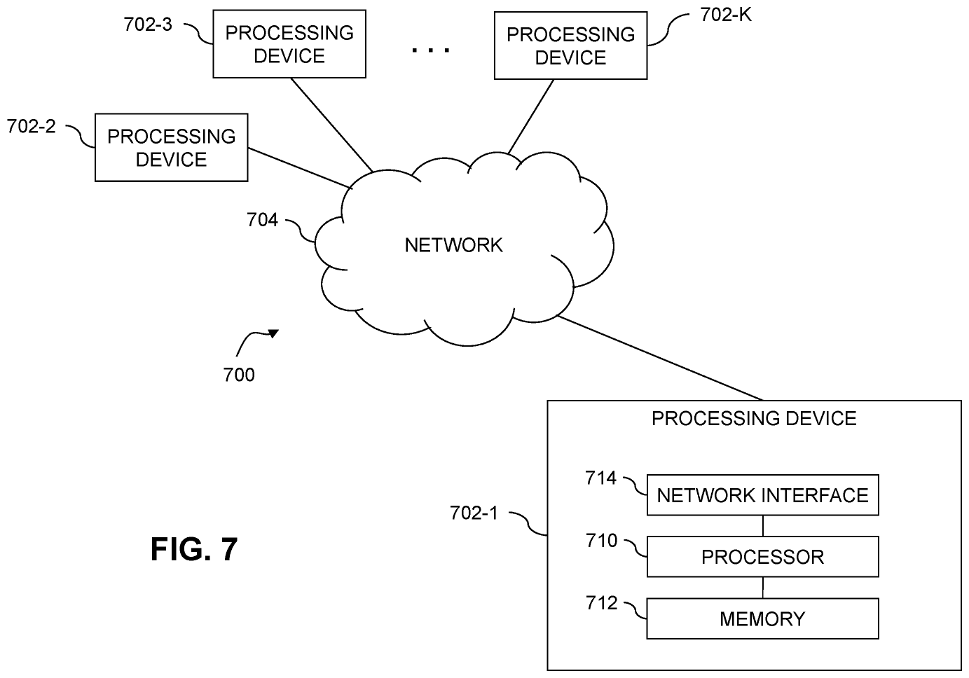

Illustrative embodiments of processing platforms utilized to implement processing devices with functionality for an authentication service for shared credentials will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. Such implementations can provide at least portions of the disclosed authentication service functionality in an information processing system of the type described above using one or more processes running on a given one of the VMs. For example, each of the VMs can implement logic instances and/or other components providing functionality associated with an authentication service for shared credentials in the system 100.

A hypervisor platform may be used to implement a hypervisor within the virtualization infrastructure 604. Such a hypervisor platform may comprise an associated virtual infrastructure management system. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system. Such implementations can also provide at least portions of the disclosed authentication service functionality in an information processing system of the type described above. For example, a container host device supporting multiple containers of one or more container sets can implement logic instances and/or other components providing functionality associated with an authentication service for shared credentials in the system 100.

As is apparent from the above, one or more of the processing devices or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 702-1 in the processing platform 700 comprises a processor 710 coupled to a memory 712.

The processor 710 may comprise a microprocessor, a microcontroller, an application-specific integrated circuit (ASIC), a field-programmable gate array (FPGA), graphics processing unit (GPU) or other type of processing circuitry, as well as portions or combinations of such circuitry elements.

The memory 712 may comprise random access memory (RAM), read-only memory (ROM), flash memory or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise various arrangements of converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for an authentication service for shared credentials provided by one or more components of an information processing system as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, user devices, server devices, authentication services, shared credentials, shared credential authentication logic and additional or alternative components. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

### APPENDIX

The following is additional example pseudocode illustrating portions of an authentication service for shared credentials for a particular website, namely, Twitter. It is to be appreciated that the arrangements disclosed herein can be modified in a straightforward manner for operation with other websites.

```
def_login_twitter(driver):
  driver.get(“twitter.com/login”)
  time.sleep(2)
  user = driver.find_element(By.TAG_NAME, “input”)
  user.clear( )
  user.send_keys(passwords[“Twitter”][0])
  buttons = driver.find_elements(By.XPATH, “//div[@role = ‘button’]”)
  buttons[2].click( )
  time.sleep(4)
  all_passwords = driver.find_elements(By.TAG_NAME, “input”)
  password = all_passwords[1]
  password.clear( )
  password.send_keys(passwords[“Twitter”][1])
  buttons = driver.find_elements(By.XPATH, “//div[@role = ‘button’]”)
  buttons[2].click( )
  cookies = driver.get_cookies( )
def _change_twitter_password( ):
  global passwords
  options = Options( )
  options.add_argument(“--headless”)
  options.add_argument(“--no-sandbox”)
  options.add_argument(“--disable-dev-shm-usage”)
  options.add_argument(“--window-size=1920x1080”)
  driver = webdriver.Chrome(options=options)
  _login_twitter(driver)
  time.sleep(2)
  alphabet = string.ascii_letters + string.digits + string.punctuation
  username, tw_old = passwords[“Twitter”]
  tw_new = “”.join(secrets.choice(alphabet) for _ in range(20))
  print(“Generated new password: { }”.format(tw_new))
  passwords[“Twitter”] = (username, tw_new)
  driver.get(“twitter.com/settings/password”)
  time.sleep(2)
  password = driver.find_element(By.NAME, “current_password”)
  password.clear( )
  password.send_keys(tw_old)
  password = driver.find_element(By.NAME, “new_password”)
  password.clear( )
  password.send_keys(tw_new)
  password = driver.find_element(By.NAME, “password_confirmation”)
  password.clear( )
  password.send_keys(tw_new)
  dump(passwords, “passwords.pkl”)
  button = driver.find_element(By.CSS_SELECTOR, ‘[data-testid=“settingsDetailSave”]’)
  button.click( )
  _logout_twitter(driver)
  driver.close( )
  driver.quit( )
```

What is claimed is:

1. An apparatus comprising:
at least one processing device comprising a processor coupled to a memory;
the at least one processing device configured to provide an authentication service for sharing access credentials of a protected resource among multiple users;
wherein the at least one processing device in providing the authentication service for sharing the access credentials is further configured:
to obtain the access credentials at least in part from a first one of the users;
to automatically provide the access credentials to at least one additional one of the users responsive to authentication of the at least one additional user and satisfaction of one or more specified distribution conditions; and
to automatically modify the access credentials responsive to satisfaction of one or more specified revocation conditions.

2. The apparatus of claim 1 wherein the protected resource comprises an access-controlled user account of a website and the access credentials comprise at least one of a username and a password.

3. The apparatus of claim 2 wherein the at least one processing device and the website are implemented at least in part on a common processing platform.

4. The apparatus of claim 2 wherein automatically modifying the access credentials responsive to satisfaction of one or more revocation conditions comprises:
accessing a designated interface of the website using the access credentials;
altering one or more portions of the access credentials via the designated interface of the website to obtain modified access credentials; and
storing the modified access credentials for subsequent utilization by at least one of the multiple users.

5. The apparatus of claim 1 wherein the at least one processing device in providing the authentication service is further configured to permit the first user to designate different sets of one or more distribution conditions for controlling provision of the access credentials to different ones of the multiple users.

6. The apparatus of claim 1 wherein the one or more specified distribution conditions comprise one or more of:
receiving a request for the access credentials by the at least one additional user;
determining that the request originates from a user device having one or more specified characteristics;
determining that the request originates from a network having one or more specified characteristics;
determining that the request originates from a particular specified user of the multiple users;
receiving an approval of the request from the first user;
receiving an approval of the request from at least one other one of the multiple users designated by the first user as being authorized to approve the request; and
receiving an approval of the request from at least one further user that is not one of the multiple users;
wherein the request is received from the at least one additional user via a corresponding user interface of the authentication service.

7. The apparatus of claim 1 wherein the one or more specified revocation conditions comprise at least expiration of a specified time period for which the at least one additional user is permitted to utilize the access credentials.

8. The apparatus of claim 7 wherein the specified time period is established at least in part by the first user via a corresponding user interface of the authentication service.

9. The apparatus of claim 7 wherein the specified time period comprises a predetermined time period not selectable by the first user.

10. The apparatus of claim 7 wherein the specified time period is selectable by the first user subject to a predetermined maximum value.

11. The apparatus of claim 1 wherein the access credentials comprise a multi-factor authentication code.

12. The apparatus of claim 1 wherein the access credentials comprise a session cookie.

13. The apparatus of claim 1 wherein the at least one processing device in providing the authentication service for sharing the access credentials is further configured to utilize the access credentials to temporarily disable a multi-factor authentication requirement of the protected resource.

14. The apparatus of claim 1 wherein the at least one processing device in providing the authentication service for sharing the access credentials is further configured to store information characterizing a registration of the authentication service to receive multi-factor authentication codes generated in conjunction with attempts to access the protected resource.

15. A computer program product comprising a non-transitory processor-readable storage medium having stored therein program code of one or more software programs, wherein the program code when executed by at least one processing device causes the at least one processing device to provide an authentication service for sharing access credentials of a protected resource among multiple users, wherein the at least one processing device in providing the authentication service for sharing the access credentials is further configured:
to obtain the access credentials at least in part from a first one of the users;
to automatically provide the access credentials to at least one additional one of the users responsive to authentication of the at least one additional user and satisfaction of one or more specified distribution conditions; and
to automatically modify the access credentials responsive to satisfaction of one or more specified revocation conditions.

16. The computer program product of claim 15 wherein the protected resource comprises an access-controlled user account of a website and the access credentials comprise at least one of a username and a password.

17. The computer program product of claim 16 wherein automatically modifying the access credentials responsive to satisfaction of one or more revocation conditions comprises:
accessing a designated interface of the website using the access credentials;
altering one or more portions of the access credentials via the designated interface of the website to obtain modified access credentials; and
storing the modified access credentials for subsequent utilization by at least one of the multiple users.

18. A method comprising:
providing an authentication service for sharing access credentials of a protected resource among multiple users;
wherein providing the authentication service for sharing the access credentials comprises:
obtaining the access credentials at least in part from a first one of the users;
automatically providing the access credentials to at least one additional one of the users responsive to authentication of the at least one additional user and satisfaction of one or more specified distribution conditions; and
automatically modifying the access credentials responsive to satisfaction of one or more specified revocation conditions;
wherein the method is performed by at least one processing device comprising a processor coupled to a memory.

19. The method of claim 18 wherein the protected resource comprises an access-controlled user account of a website and the access credentials comprise at least one of a username and a password.

20. The method of claim 19 wherein automatically modifying the access credentials responsive to satisfaction of one or more revocation conditions comprises:
accessing a designated interface of the website using the access credentials;
altering one or more portions of the access credentials via the designated interface of the website to obtain modified access credentials; and
storing the modified access credentials for subsequent utilization by at least one of the multiple users.
